(19) United States
(12) Patent Application Publication
(10) Pub. No.: US 2009/0121431 A1
(43) Pub. Date: May 14, 2009

(54) SYSTEM AND METHOD FOR PROVIDING POKER PLAYER TRACKING AND BONUS EVENTS

(75) Inventors: Richard M. Rader, Albany, OR (US); Eric W. Lancaster, Las Vegas, NV (US)

Correspondence Address: K&L Gates LLP, P.O. Box 1135, CHICAGO, IL, 60690, US

(73) Assignee: IGT, Reno, NV (US)

(21) Appl. No.: 12/352,996

(22) Filed: Jan. 13, 2009

Related U.S. Application Data
(62) Division of application No. 11/215,474, filed on Aug. 30, 2005.

(51) Int. Cl. A63F 11/00; A63F 1/00; A63F 13/00

(52) U.S. Cl. 273/274; 273/292; 463/25

(57) ABSTRACT

A gaming system having a gaming table and including a progressive jackpot funded by a portion of the house rake of a card game played at the gaming table. The gaming system includes a tracking system capable of identifying and tracking cards dealt and wagers placed in order to identify frequent players and provide complimentary items accordingly. The gaming system is also capable of notifying a player at a remote gaming device that a seat at the gaming table is open.

### PRIORITY CLAIM

This application is a divisional application of U.S. patent application Ser. No. 11/215,474, filed on Aug. 30, 2005, the entire contents of which are incorporated herein.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

In recent years poker has become very popular. Gaming establishments are increasingly offering poker rooms that include many live gaming tables where players can play against each other. In return for providing these gaming tables and services to the players, the casinos generally take a small percentage of the total amounts wagered in each hand. This percentage is generally referred to as the rake and the amount represents a fair return to the casino for providing these services to the players. Despite the current popularity of poker, many gaming establishments do not realize the full profit potential of the gaming tables because poker seats remain empty, because there is not enough advertised interest in the poker room, or because the games do not hold the player's interest over an extended period of time. Also, when the poker room is busy, players may be frustrated by having to wait in line in order to get a seat at the table.

In general, poker hands consist of five cards dealt from a 52 card deck. There are nine general categories of hands, ranked from highest to lowest, as shown in Table 1.

TABLE 1
Ranking of Poker Hands by Category

| Rank | Name | Example |
|---|---|---|
| 1 | Straight Flush | K [symbol] Q [symbol] J [symbol] 10 [symbol] 9 [symbol] |
| 2 | Four of a Kind | J [symbol] J♡J♦J [symbol] 3 [symbol] |
| 3 | Full House | A♡A♦A [symbol] 6♦6 [symbol] |
| 4 | Flush | A [symbol] J [symbol] 8 [symbol] 6 [symbol] 2 [symbol] |
| 5 | Straight | 8♦7 [symbol] 6 [symbol] 5 [symbol] 4 [symbol] |
| 6 | Three of a Kind | Q [symbol] Q♡Q♦6♦2 [symbol] |
| 7 | Two Pair | 8♦8♡5♡5 [symbol] 2 [symbol] |
| 8 | One Pair | K♦K [symbol] 8 [symbol] 7 [symbol] 2♡ |
| 9 | No Pair | A♡10 [symbol] 7♦5 [symbol] 3 [symbol] |

Within each category, hands are ranked according to the rank of individual cards, with an Ace being the highest card and a two being the lowest card. There is no difference in rank between the four suits of cards. All hands can be ranked in a linear ranking from highest to lowest. Because suits are all of the same value, however, there are multiple hands that have identical rankings. For example, there are four equivalent hands for each type of straight flush, four of a kind, or flush, there are over a hundred equivalent hands for each two pair variation, and there are over 1,000 equivalent hands for each type of no-pair hand.

Poker is characterized by rounds of card dealing and wagering. Numerous variations of poker exist, including Five Card Draw, Five Card Stud, Seven Card Stud, Hold'em (also called Texas Hold'em), Omaha (also called Omaha Hold'em), and Pai-Gow. The variations in these games generally differ in the manner in which cards are dealt and in the manner and frequency in which bets are placed. Various criteria may also be used to determine the winning hand, including highest ranking hand, lowest ranking hand (Low-Ball), and high and low hands each win half (High-Low).

In certain variations of poker, a round of play begins when each player has placed an initial bet, called the ante, into the pot. The term pot refers to the total accumulation of antes and wagers made during a particular game. However, in other poker variations, such as Texas Hold'em, only two players at a table make the initial bets, commonly referred to as blinds. These blinds include a large blind and a small blind. The large blind is typically twice the value of the small blind. In a blind based game, all players are eligible to play, even if they did not initially place the large blind or the small blind. After the players have anted or placed the blinds, depending on the game, each player eligible for play is dealt an initial set of cards.

The number of cards dealt depends on the particular variation of poker being played. For example, in Five Card Draw, each player is initially dealt five cards. In Texas Hold'em, Five Card Stud and Seven Card Stud, each player is initially dealt two cards. These cards are typically dealt face-down; however, depending on the game, some of the cards may be dealt face-up to the player. For example, in Five Card Stud, each player is initially dealt one card face-up and one card face-down. In Texas Hold'em, each player is initially dealt two cards face-down which are commonly referred to as the hole cards.

After the initial deal, a first round of betting begins, where the players have the opportunity to place wagers. If a player places a wager, that wager must be matched (i.e., called) or raised by each player that wants to remain in the game. A raise includes matching the previous wager and increasing the total bet. A player who does not match a bet drops out of the game or folds. A round of betting ends when either every player but one has folded, or when the highest bet or raise has been called by each remaining player such that each remaining player has wagered the same amount into the pot during the round.

Depending on the variation of poker being player, each game may have several rounds of wagering, each round of wagering generally preceded by dealing one or more cards. If two or more players remain after a particular round of wagering, either more cards are dealt, or there is a showdown, depending on the game variation being played. A showdown occurs when two or more players remain in a game after the last round of wagering has been completed for a particular round. A player wins a game of poker either by having the highest ranking hand when a showdown occurs, or by being the last remaining player in the game after all other players have dropped out, or folded. At a showdown, each player displays the player's hand to the other players. If two or more players have identically ranked hands that are the highest ranking hands, the pot is split evenly between them.

Gaming establishments have long recognized that progressive jackpots tend to increase excitement and hold a player's interest in a game. Recent developments in live gaming table technology include the incorporation of a progressive jackpot feature. For example, one system provides a live card game that includes a progressive jackpot feature, where a player becomes eligible to win the progressive jackpot by making an optional additional wager. The additional wager funds the progressive jackpot. Another known system provides for an optional progressive wager, where the gaming table includes a separate coin acceptor at each player position that is operable to receive an optional progressive bet. In another system, a gaming table includes an apparatus operable to receive the optional progressive game token and to control a jackpot meter. The apparatus is built into the game table and any number of tables can be networked together for a single progressive jackpot.

A common characteristic of all of the above approaches that include conventional progressive systems for live gaming tables, is the requirement that each player must place a separate optional progressive wager. Therefore, participation in the progressive jackpot feature is at the option of the player, and contributions are only made to the progressive jackpot when a player makes the optional wager. Furthermore, the variety of progressive table games is limited and they do not adequately reward the frequent players.

In addition to recognizing the value of progressive jackpots, gaming establishments have also recognized the value of building customer loyalty through identifying frequent customers and rewarding them for their patronage. These rewards are typically referred to as comping. To properly identify customers that are deserving of special comp rewards, automated player tracking technologies exist to accurately identify these individuals. The cumulative history of a particular player's gaming activity, which is included in a player profile, enables gaming establishments to target individual players with direct marketing promotions or customized compensation plans.

In existing player tracking systems, a player is issued a player identification card which has an encoded player identification number that uniquely identifies the player. Player tracking on gaming devices such as slot machines, is typically accomplished with a card reader mounted to the gaming device. When the player first sits down at a gaming machine, the player inserts the card into the card reader. The reader reads the player identification number off the card and communicates information through a network to a central computer regarding the player's subsequent gaming activity.

Subsequent systems have adapted the card reader technology to live gaming tables. Existing live gaming table tracking systems include magnetic stripe card readers mounted to the table for entering player identification information on the magnetic stripe cards. In certain of these systems, wagering information is entered by a pit boss using a touch screen mounted to the table. These systems require a manual data entry of the wagers, and thus do not fully automate data collection for player tracking.

Other systems have enhanced tracking systems for live gaming tables that incorporate chip identifiers and card identifiers. These technologies help to further automate the tracking and comping process. One example of an optical chip reading technology includes mounting a black and white CCD sensor into a reading turret placed in proximity to a player's wagering area. In this system, each wagering chip includes patterns of repeated coding around the periphery of the chip. The patterns are identifiable by the CCD sensor. Therefore, the gaming system is able to determine the amount of each wager by imaging all of the chips and associating the patterns with a chip value.

One example of a playing card identifier is described in U.S. Patent Application No. 2003/0171142 to Toshiyuki et al., which discloses a card data reader where the card data recorded on the back of the playing card will be read by an internal image sensor. Another example of tracking technology is described in U.S. Patent Application No. 2002/0049085 to Richard et al. (“Richard”), which discloses a table monitor that automatically images the activity occurring at a gaming table. The Richard application describes an imaging system that makes a periodic comparison of captured images identifying player wagering, as well as the appearance, removal and position of cards and other game objects on the gaming table. Therefore, a card tracking system enables the casino to automatically track cards dealt to a player and wagering patterns, and store the information into memory.

Although gaming establishments are able to comp frequent players based on information obtained from tracking systems on live gaming tables, the gaming tables do not include progressive jackpot features. Also, the progressive jackpot features are not funded by a portion of the rake. Furthermore, gaming tables that include progressive jackpot features do not provide a jackpot award based, in part, on tracked cards and/or historical game play information obtained through a tracking system.

A need exists for a progressive jackpot system for live gaming tables that permits progressive jackpot awards while minimizing interference with the conventional play of the game by not requiring a separate progressive wager.

A need exists for new progressive jackpot features for live gaming tables where the jackpot features are, at least in part, related to player tracking information and where the jackpot award effectively reward (i.e., comp) a player for frequent play.

### SUMMARY

One embodiment of the present disclosure provides a gaming system including a processor, a gaming table for a card game, and a progressive jackpot funded by a portion of the house rake. More specifically, the gaming table includes a plurality of player positions, a dealer position, at least one wagering area, and at least one display device operable to display the progressive jackpot award, wherein the card game employs at least one deck of playing cards. The deck of playing cards may be a standard fifty-two card deck, or may be any other suitable type of deck, such as a forty-eight card Pinochle deck, and may further include Jokers or Wild cards. The progressive jackpot is awarded to a player if a player satisfies a predetermined set of criteria. Therefore, in the gaming system of this embodiment, every player at the table is automatically qualified to win the progressive jackpot award without having to place a separate additional wager. This adds excitement to the game and encourages more players to participate at the gaming table.

In one embodiment, the house rake is automatically calculated. The gaming system includes a gaming table with a tracking system, where the tracking system includes at least one chip identifier. The chip identifier identifies the amount of each wager placed in one or more wagering area and the tracking system communicates this information to a central processor. The processor calculates the value of the rake, based in part, on the sum of all wagers identified by the tracking system. Therefore, the calculated rake enables the dealer to determine and remove the rake from the table (at the end of the game) and functions as a check and balance against the manual chip count. This enables the casino to track at least part of the revenue from the gaming room. In one embodiment, the gaming system also includes a progressive jackpot that is funded by a portion of the house rake. Because the rake is automatically calculated based on information obtained from the tracking system, the gaming system is operable to apply a predetermined portion of the collected rake to the progressive jackpot and causes this increased award to be updated on a display device. Accordingly, the progressive jackpot award continues to grow without any apparent interference with the game play.

In one embodiment, a gaming system includes a progressive jackpot award that is based on the highest ranking hand achieved during a particular period of time. The gaming system includes a tracking system which includes at least one player identification input device, and a card identifier operable to identify each card dealt to a player position. The tracking system communicates the identity of each card to the processor. At the end of a round of play, the processor updates a player profile associated with the player identification card with the rank of the player's hand. Therefore, the gaming system keeps a record of every hand dealt to a player along with the date and time the hand was dealt. Players that have achieved the high ranking hand are encouraged to continue playing until the progressive jackpot is awarded. Furthermore, if the highest recorded ranking hand can be beaten, other players are encourage to continue playing in hopes of getting an even higher ranking hand. The more hands that a player plays during a particular period of time, the more likely it is that the player will achieve the highest ranking hand. Accordingly, the gaming system of this embodiment tends to reward frequent players and functions as a type of comp. In one embodiment, the period of time is configurable and may include off peak hours. In one embodiment, the progressive jackpot award is funded by a portion of the rake, as mentioned above.

In one embodiment, a gaming system includes a gaming table and a progressive jackpot award. The gaming system includes a tracking system, as described above, to keep a record of every hand played and the time the hands were played. In this embodiment, the progressive jackpot award is provided to a randomly selected player if the player is actively registered at the gaming system and if the player profile indicates that the player had placed at least one wager during a previous period of time. Therefore, this system rewards frequent players and encourages people to come back and play at later times. In one embodiment, the previous period of time may be during off peak hours to encourage play during slow periods.

In one embodiment, the gaming system includes a table configured for a poker game and includes a progressive jackpot that is awarded to a player achieving one of several high ranking poker hands (e.g., Four of a Kind or a Straight Flush), where the progressive jackpot is funded by a portion of the rake. In one embodiment, the poker game includes dealing at least one hole card and at least one community card. In this embodiment, the progressive jackpot award is provided to the player that has achieved a predetermined combination of cards utilizing the player's hole cards. Therefore, the progressive feature of this embodiment provides excitement to a player that has first been dealt one or more hole cards that could potentially form one of the predetermined high ranking hands. This adds an additional twist to the game, because a poker player that is dealt qualifying hole cards may reveal their excitement to other players at table. Other players at the table may have an advantage by being able to determine what cards the player is holding.

In one embodiment, a gaming system includes a progressive jackpot feature for a no-limit poker game. In this embodiment, the gaming system randomly selects a player at a particular point in time. The jackpot award is provided to the randomly selected player if that player has wagered all of their chips and subsequently loses the hand. Therefore, a player that has lost all of their chips has the possibility of being compensated by winning a potentially large jackpot. Also, this may encourage more players to risk going all-in in the hope of winning a progressive jackpot. In one embodiment, the gaming system causes the display device to display the randomly selected player prior to the player's decision to go all-in. In another embodiment, the jackpot award is provided to a randomly selected player that has gone all-in a predetermined number of times, regardless of whether the player wins or loses each of the hand. Alternatively, the jackpot award is provided to a player that has gone all-in a predetermined number of times and won each hand.

In one embodiment, a gaming system including a table for a card game including a notification system to inform players that a seat at a poker table is vacant. The gaming system includes a notification system operable to identify a vacant player position at the gaming table, retrieve a waiting list of potential players from a database and determine if the first potential player on this waiting list is actively playing at one of a plurality of remote gaming devices or gaming tables. The remote gaming device or remote gaming table must be connected to the card table through a linked network and must include a player identification input device. The notification system causes the processor to send a vacancy notification through the linked network to the potential player playing at the remote gaming device. In one embodiment, the notification may be a message displayed on a the remote gaming device or remote gaming table.

Additional features and advantages are described herein, and will be apparent from the following Detailed Description and the figures.

### BRIEF DESCRIPTION OF THE FIGURES

FIG. 1 is a front perspective view of one embodiment of the gaming system of the present disclosure.

FIG. 2 is a schematic diagram of the data network that one or more of the gaming systems of the present disclosure are connected to.

FIG. 3 is a front perspective view of the dealer display device.

FIG. 4 is a top view of one embodiment of the gaming system of the present disclosure including a progressive jackpot feature.

FIG. 5 is a top view of one embodiment of the gaming system of the present disclosure including a progressive jackpot feature.

FIG. 6 is a top view of one embodiment of the gaming system of the present disclosure including a progressive jackpot feature.

FIG. 7 is a top view of one embodiment of the gaming system of the present disclosure including a progressive jackpot feature.

### DETAILED DESCRIPTION

One or more embodiments of the present disclosure comprise a gaming system including a live table game and an activity tracking and reward system. The tracking system is configured to collect and store raw data relating to the wagering activities of players at a gaming table. The present disclosure also includes methods of utilizing the obtained data. For example, the data may be used to calculate the house rake, where the house rake may be based on the size of the pot at the end of a hand. In one embodiment, certain criteria are applied to the obtained data to determine if a player qualifies to receive a progressive jackpot award. In another embodiment, the collected data is analyzed to determine a player's wagering history to determine whether or not the player is entitled to certain complimentary items. In another embodiment, the gaming system notifies a player that a seat is vacant at a poker table, where the player is located at a remote gaming device or gaming table.

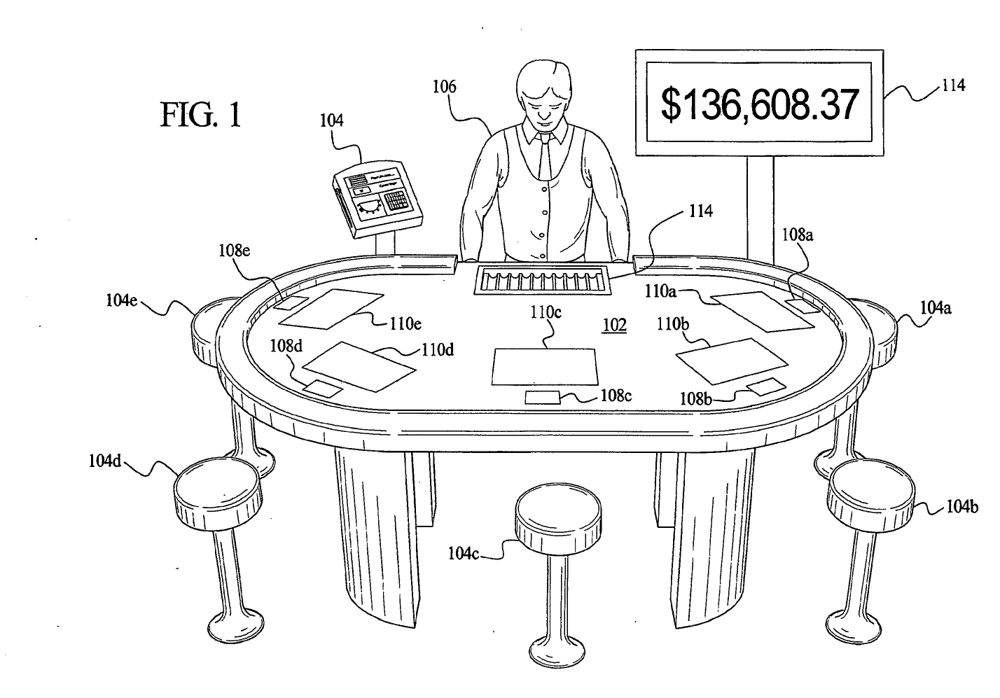

As illustrated in FIG. 1, a typical live gaming table includes several components. The gaming table 100 includes a suitable support structure 101, such as one or more legs. The table includes a playing surface 102, a plurality of player positions 104a, 104b, 104c, 104d and 104e, and a dealer position 104f. The gaming table generally includes a chip tray 106 for holding several stacks of the dealer's chips. The dealer may use the chip tray 106 to collect a percentage of chips from the pot according to the house rules. This percentage take is generally referred to as the rake, as described above. The dealer may also use the chip tray to make change for a player or allow a player to buy into a game. In this example, there are five player positions. It should be appreciated that the gaming table could accommodate any suitable number of playing positions and players so as not to interfere with game play. In one embodiment, the table game includes a plurality of wagering areas 108a, 108b, 108c, 108d and 108e where all players place their bets. It should be appreciated that the table game may also include a community wagering area (not shown), that includes all the chips in the pot. The table game also includes a plurality of play areas 110a, 110b, 110c, 110d and 110e associated with each of the player positions. Cards are dealt by the dealer substantially within the respective play areas, such that cards dealt to a first player position are not confused with cards dealt to a second different player position. In the illustrated embodiment, the gaming table includes at least one display device 114 operable to display any active bonus games and/or the current value of one or more progressive jackpots. In another embodiment, the gaming table could include a plurality of display devices each associated with a player position. In the illustrated embodiment, the display device provides information to the player that includes the value of any progressive jackpots.

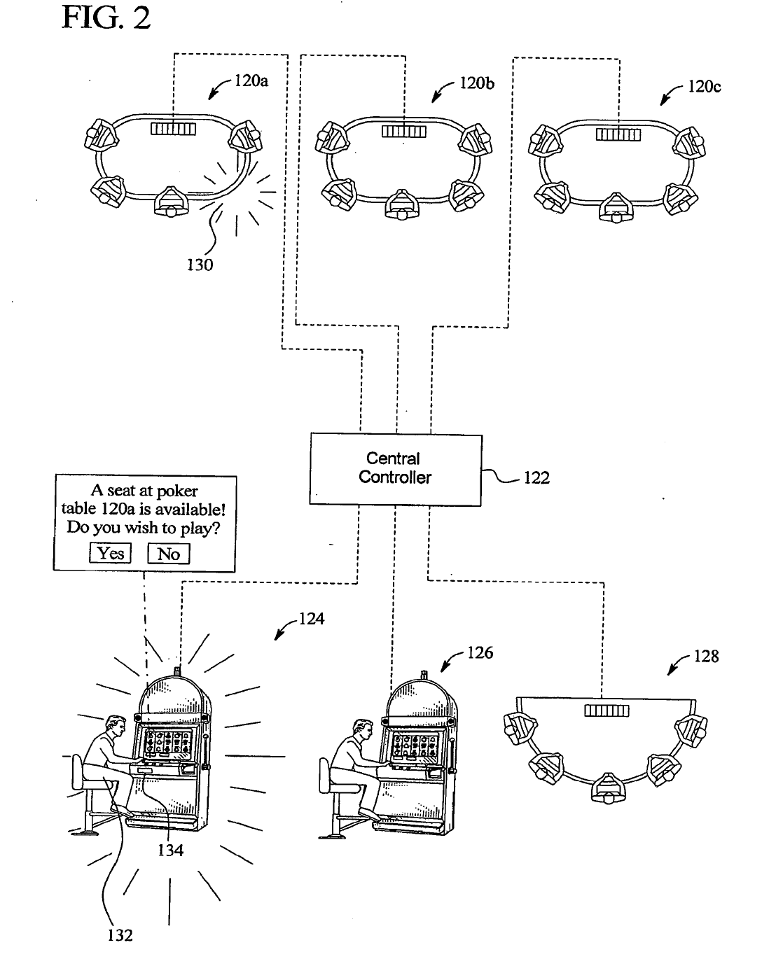

As illustrated in FIG. 2, a plurality of the gaming systems 120a, 120b and 120c are capable of being connected to a data network. In one embodiment, the data network is a local area network (LAN), in which one or more of the gaming systems are substantially proximate to each other and an on-site central server or controller 122 as in, for example, a gaming establishment or a portion of a gaming establishment. In one embodiment, on or more gaming systems may be connected to a plurality of different gaming machines 124 and 126 and/or gaming tables 128. For example, the gaming system may be connected to one or more slot machines, video poker machines, or Blackjack tables, provided that the gaming devices or gaming tables have appropriate player identification input devices, such as a magnetic card reader.

In another embodiment, the data network is a wide area network (WAN) in which one or more of the gaming systems are in communication with at least one off-site central server or controller. In this embodiment, the plurality of gaming systems may be located in a different part of the gaming establishment or within a different gaming establishment than the off-site central server or controller. Thus, the WAN may include an off-site central server or controller and an off-site gaming system located within gaming establishments in the same geographic area, such as a city or state. The WAN gaming system may be substantially identical to the LAN gaming system described above, although the number of gaming systems in each system may vary relative to each other.

In another embodiment, a plurality of gaming systems at one or more gaming sites may be networked to a central server in a progressive configuration, wherein a portion of the rake may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming systems distributed throughout a number of properties at different geographical locations including, for example, different locations within a city or different cities within a state. In one embodiment, a community display device (not shown) displays a progressive award that can be viewed from a plurality of gaming systems. The progressive award may be determined by several rounds of poker, or it may be determined by contributions from different gaming tables throughout the gaming establishment, each gaming table linked through a network, as described above.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between the gaming system hardware and software and the host site computer.

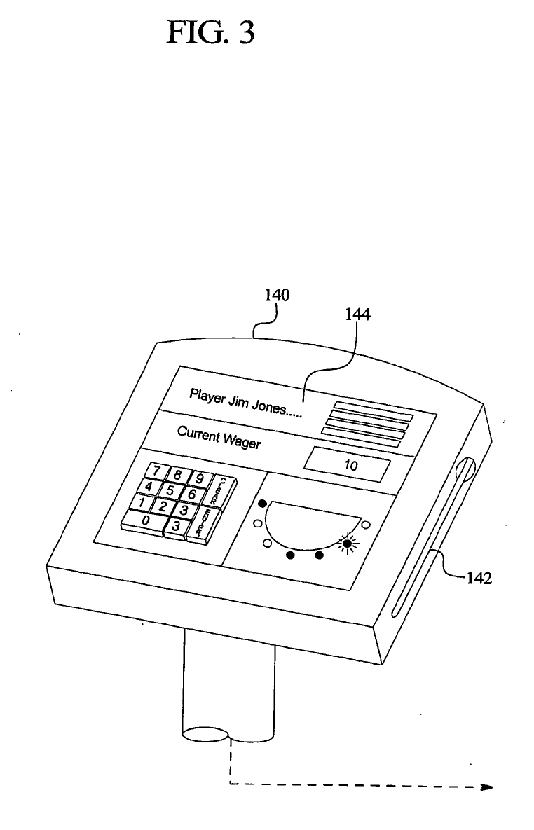

In an embodiment, the gaming table is associated with a tracking system. As illustrated in FIG. 3, the tracking system includes at least one computer interface 140 located at each gaming table and which is accessible to the dealer. In one embodiment, the computer interface includes a player identification card reader 142 and a touch screen monitor 144. The touch screen monitor enables a dealer to input information related to a player or the individual wagers. For example, the dealer may manually enter the amount of each wager for each player. It should be appreciated that any suitable method may be used to identify a player or to input wagers.

In another embodiment, the tracking system further includes an automatic chip identifier (not shown) capable of identifying the amount of each wager. The chip identifier may include technology based on RFID or optically based, as described above. In one embodiment, the dealer is able override the chip identification system and manually input a wager. In another embodiment, the tracking system further includes a card identifier operable to identify the cards dealt to each player and communicate the information to the processor.

Gaming Table Vacancy Notification

In one embodiment, where the gaming device includes a tracking system, the gaming table includes an integrated player identification input device operable to check a player into a table. In one example, the input device is a magnetic card reader operable upon swiping a magnetic player identification card (not shown). Therefore, the system is capable of keeping track of the players at a table as well as how many empty seats there are. If all of the gaming tables are full, a processor generates a waiting list for other players wishing to play and stores this into a memory device. Referring back to FIG. 2, in one embodiment, the gaming systems 120a, 120b and 120c are networked to different gaming machines and/or gaming tables throughout the casino, as described above. The gaming machines may be traditional slot machines, video poker games, video Blackjack games, or any other suitable type of gaming machine connected through the network. In this embodiment, if a potential player 132 on the waiting list is playing at another remote gaming machine 124 that includes a player identification input device (not shown), the player can log into the network by inserting their player identification card into said gaming machine. The gaming system 120a with the vacant player position 130 causes the processor to provide notification to the potential player 132 through the network that a seat at a gaming table is available. For example, a player may be playing a traditional slot machine on the opposite end of the casino from the table games. In one embodiment, the slot machine includes a display capable of displaying a message informing the player that a poker seat is available and they are next on the waiting list. In one embodiment, the gaming machine 124 further includes an input 136 to allow the player to accept or decline the open seat at the poker table. If the player declines the poker seat, a notification is sent from the remote gaming machine 124 to the gaming table 120a. The gaming system then attempts to notify the next potential poker player on the waiting list. This allows for maximum utilization of both the gaming tables and of other gaming devices by limiting the need to wait in line for a gaming table. Moreover, this eliminates or minimizes any player frustration associated with having to wait for a seat in physical proximity to the poker room.

In another embodiment, the display device on the remote gaming device informs the player of the value of any progressive jackpots associated with the gaming system 120a. In another embodiment, the gaming establishment provides a number of large community displays (not shown) that indicate the value of any progressive jackpots. Therefore, when the jackpots become large there will be a larger motivation for the player to participate at the gaming tables.

Table Game Progressive Jackpot Funded by the House Rake

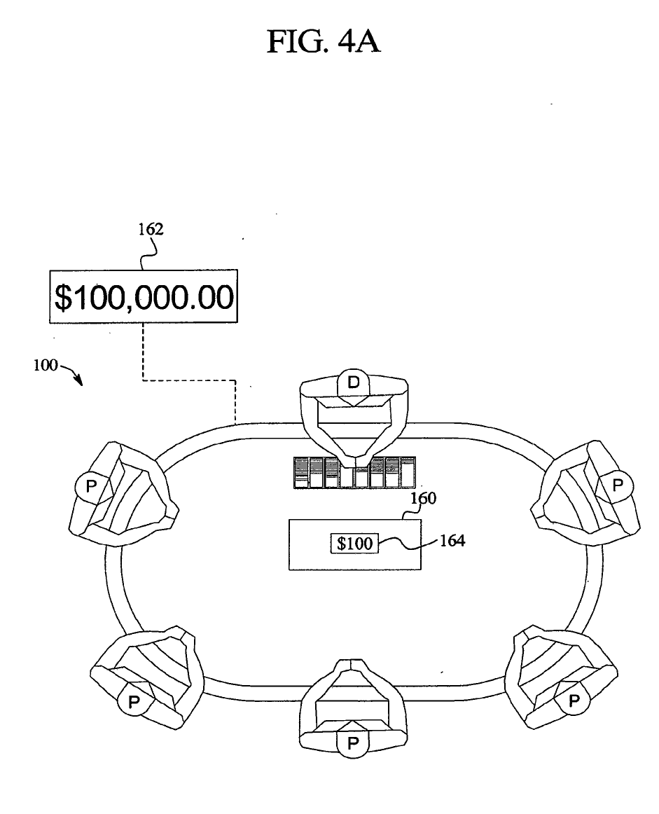

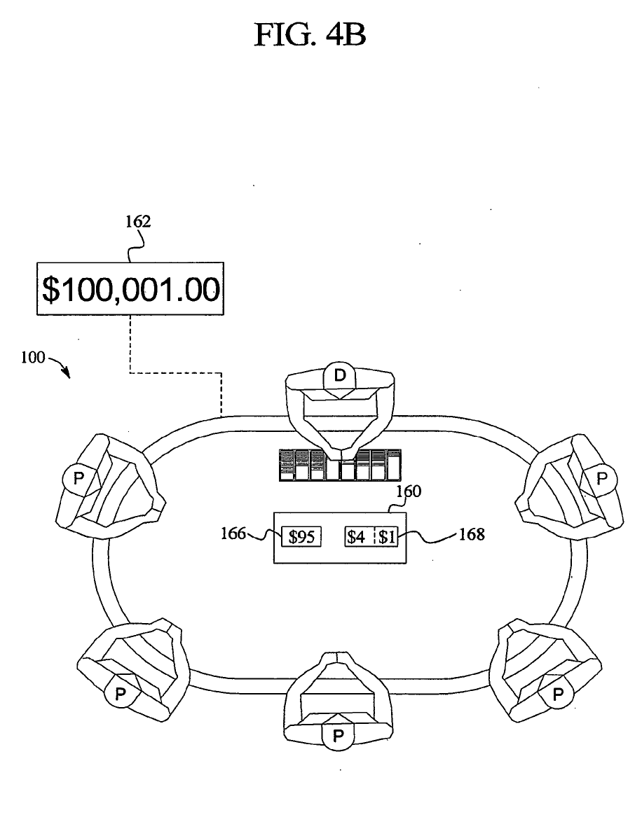

In one embodiment, at least one type of bonus game will be available to all players in the form of a progressive jackpot. The progressive jackpot is funded by a portion of the rake and does not require a separate optional wager by a player. The casino allocates a portion of the rake to be applied to a progressive jackpot in one or more different bonus games. In the example illustrated in FIGS. 4A and 4B, the gaming table 100 includes a wagering area 160 and a progressive jackpot display 162. The progressive jackpot award is initially $100,000.00 as indicated by the progressive jackpot display 162. FIG. 4A illustrates the end of a particular round of a card game where the resultant pot 164 is one-hundred dollars. The house rake for this particular game is 5% of the pot, or $5. However, it should be appreciated that the rake may be determined in any suitable matter, as discussed above. As illustrated in FIG. 4B, 20% of this rake 168 amount, or one dollar, is allocated to the progressive jackpot. However, it should be appreciated that the portion of the house rake may be any suitable amount or percentage, and determined in any suitable manner. The progressive jackpot award increases to $100,001.00, as indicated by the progressive jackpot display 162. Accordingly, the dealer provides the winning player(s) with the resultant pot 166 of ninety-five dollars and the gaming establishment retains four dollars. In one embodiment, several gaming systems are linked together through a network as described above, and a portion of the rake from each table contributes to the progressive jackpot award.

Lose to Win Progressive Jackpot

In one embodiment, a progressive jackpot game is applied to a poker game. In certain poker variations such as Pot Limit or No Limit games, the player often has the option to wager all of their remaining chips. This is commonly referred to as going all-in. In one embodiment, the progressive jackpot is randomly awarded at a particular point in time to a player who has gone all-in and lost all of their chips. The player must have registered at a gaming table at a previous point in time and must also have been continuously playing up to the point in time at which the progressive jackpot is awarded. The player can become registered at a table by swiping a player card into a card reader, as discussed above with reference to FIG. 3. In one example, in order to qualify to win the progressive jackpot award, the player must have been registered at the gaming system at the beginning of the hour. In one example, at five minutes after the hour, a central processor randomly selects a single player position located at one of a plurality of gaming tables. If the selected player had wagered and lost all of their chips, the player would win at least a portion of the progressive jackpot.

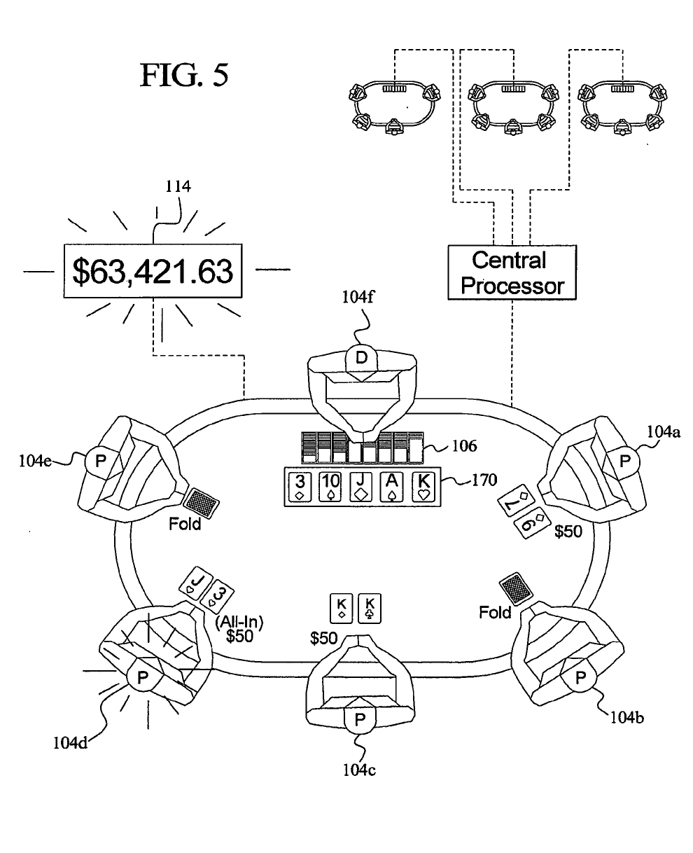

In the example illustrated in FIG. 5, the card game is the poker variation Texas Hold'em. As discussed above with regard to Texas Hold'em, the player's final hand is the best five cards selected from two hole cards and five community cards 170. The central processor randomly selected the player at the fourth player position 104d. This example illustrates the end of a round of play where the player's hand at the first player position 104a is only Ace-High (i.e., A), the player at the second player position 104b has folded, the player's hand at the third player position 104c is Three-of-a-Kind (i.e., K.diamond-solid.KK); the player's hand at the fourth player position 104d is Two-Pair (i.e., J J.diamond-solid.3.diamond-solid.3), and the player at the fifth player position 104e has folded. Therefore, the player at position 104c wins the pot by having the highest ranking hand of Three-of-a-Kind. However, because the player in the fourth player position 104d was randomly selected by the processor, was registered to play at the beginning of the hour, wagered all of their chips, and lost the hand to the player in the third player position 104c, the gaming system provides the fourth player with at least a portion of the progressive jackpot award.

In one embodiment, the gaming system informs the player that they are eligible to win the progressive jackpot award prior to the player deciding to wager all of their chips. In another embodiment, the player would be informed that they are eligible after they have wagered all of their chips. In another embodiment the player would be notified of winning the progressive jackpot award after they have wagered and lost the hand. In another embodiment, the progressive jackpot is funded by a portion of each rake from one or more gaming tables.

Therefore, winning the progressive jackpot award would more than compensate a player after they have wagered and lost all of their chips. Players may also be encouraged to wager all of their chips in the hope that they may qualify for the larger progressive jackpot award. Players that may not normally wager all of their chips with a particular hand may be more inclined to do so if they believe that they may be eligible for a potentially large jackpot.

Four of a Kind and Straight Flush Progressive Jackpot

In one embodiment, a progressive jackpot is applied to poker game variations that include one or more community cards, such as Texas Hold'em. Although examples are provided with reference to the poker variation of Texas Hold'em, it should be appreciated that the progressive jackpot may be applied to any suitable poker variation, as described above. The progressive jackpot is awarded when the player achieves a predetermined combination of cards.

In one embodiment, the predetermined combination of cards is a natural Four-of-a-Kind. A natural Four-of-a-Kind requires that the player is dealt a pair for their hole cards and then the remaining pair to form the Four-of-a-Kind is dealt during the flop, the turn, or the river. Therefore, two of the four cards are the player's hole cards and the other two cards are selected from the community cards.

In another embodiment, the predetermined combination of cards is a natural Straight Flush. A natural Straight Flush requires that the player is dealt two suited connectors for their hole cards. According to one definition, suited connectors are two cards of the same suit that are consecutive in rank (e.g., 2 3 or Q K). Under this definition, the player receives a natural Straight Flush only when the hole cards are consecutive and of the same suit. According to a second definition, suited connectors are any two cards of the same suit which, together with three additional cards, can potentially form a straight. Under this second definition, some examples of suited connectors include: A 3; Q 9; and 7.diamond-solid.9.diamond-solid. Hands such as 2 4 are also commonly known as one gap hands because exactly one card (i.e., the 3) is required to connect the 2 and the 4 to form the Straight Flush. Similarly, two gap and three gap hands can potentially form a straight with three additional cards. The remaining three cards to form the Straight Flush must be dealt on the flop, the turn, or the river. Therefore, two of the five cards to form the Straight Flush are the player's hole cards and the other three cards are community cards.

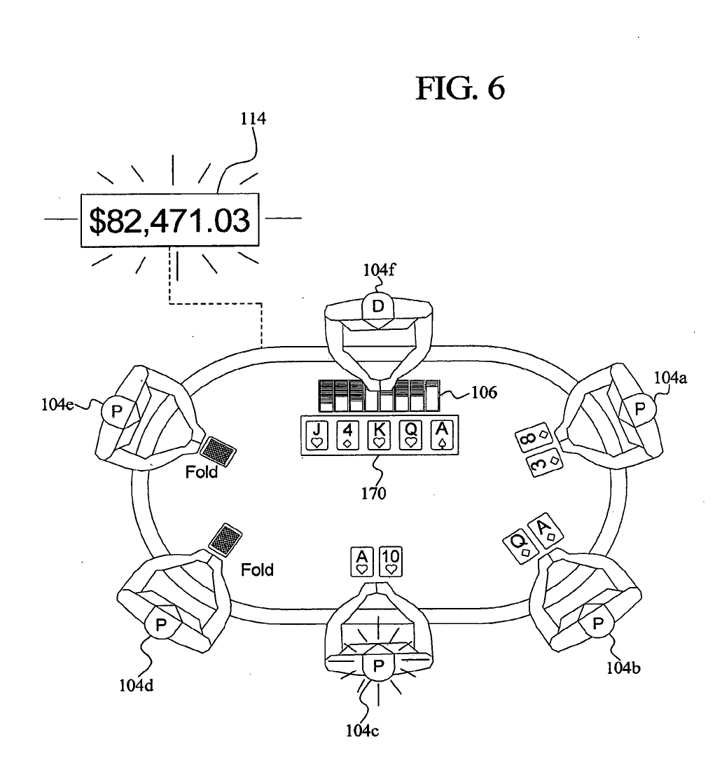

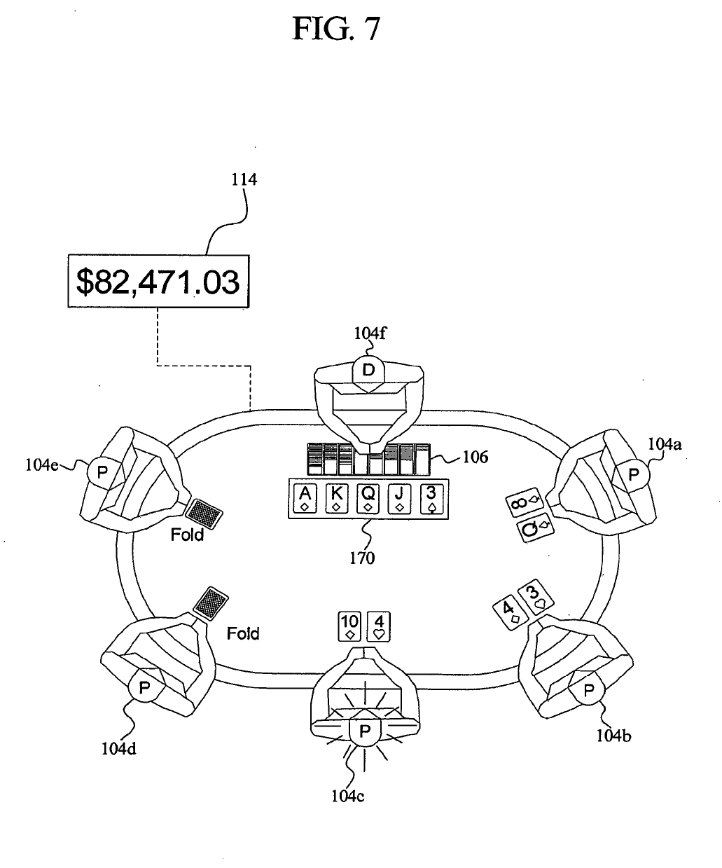

In the examples illustrated in FIGS. 6 and 7, both players seated at player position 104c have achieved a Royal Straight Flush. In FIG. 6, both of the player's hole cards (i.e., A 10) formed part of the Straight Flush (i.e., A K Q J 10). Therefore, this player achieved a natural straight flush and is provided at least a portion of the progressive jackpot award 114. However, in FIG. 7, only one of the player's hole cards (i.e., 10.diamond-solid.) formed part of the Straight Flush (i.e., A.diamond-solid.K.diamond-solid.Q.diamond-solid.J.diamond-solid.10.diamon-d-solid.). Therefore, this player did not achieve a natural straight flush because only one the hole cards was used. Accordingly, although this player will undoubtedly win the pot, the player does not win the progressive jackpot award.

Best Hand Progressive Jackpot.

In one embodiment, the gaming system includes a gaming table adapted for a poker game and includes a progressive jackpot award provided to a player who achieves the highest ranking hand during a specific time period. In one example, the tracking system tracks every hand dealt for all registered players during a specific period of time, such as a twenty-four hour period. After the expiration of the time period, the gaming system awards at least a portion of the progressive jackpot to the player who has achieved the highest ranking hand during the previous time period.

In an example where the card game is Five Card Draw, the best hand may be the first five cards dealt to the player or it may be the player's final hand after drawing new cards. In another example, the poker game is a poker variation involving hole cards and community cards, such as Texas Hold'em. In this example, the best hand must include both of the player's hole cards. In other embodiments, the best hand progressive jackpot may be applied to other table games including, for example, a Blackjack game. In an example of a Blackjack game, the progressive jackpot may be awarded to the player that has achieved the best five card poker hand formed from the cards dealt in a play of the underlying Blackjack game. In this example, the five card poker hand is preferably formed from an underlying Blackjack hand including at least five cards.

In one embodiment, the best hand progressive jackpot is only awarded to a player only if they are registered at the time the progressive jackpot is awarded. Therefore, a player who either knows or believes that they have the best hand would be motivated to continue playing until the expiration of the time period. Otherwise, the player may end up forfeiting the award to a different player. This possibility of forfeiture also motivates players who may have the second or third highest hands to continue to play. The gaming establishment may further include a linked display device that displays the current highest ranking hand. Therefore, all players would know what they would need to beat in order to win the progressive jackpot.

In one embodiment, the progressive jackpot is funded at least partially by a portion of the rake.

Play to Win Progressive Jackpot

In one embodiment, the progressive jackpot is randomly awarded to a player who placed at least one wager during a previous qualifying time period and who is currently registered at a gaming table. In this embodiment, the gaming system includes a tracking system as described above, and the tracking system provides wagering information to the processor, such that a wagering history can be made for each player. In one example, the gaming system randomly selects a currently registered player and then determines from that player's wagering history whether or not the player had placed at least one wager during the specified time period. If the player had placed at least one wager, the player receives at least a portion of the jackpot award. If the randomly selected player did not place a wager, the gaming system randomly selects another player. Therefore, this type of progressive jackpot rewards the frequent player and encourages people to play more often. Also, players do not need to achieve a high ranking hand in order to qualify to win the jackpot award.

In one embodiment, the gaming establishment may provide the jackpot award during times when activity in the gaming establishment is slow. This strategy would encourage more players to play during off-peak periods. In another embodiment, the qualifying time period may be during these off-peak periods. In one embodiment, the progressive jackpot is at least partially funded from a portion of the rake.

Game Play Management

In one embodiment, the gaming table computer interface (as shown in FIG. 3) enables the dealer to set the wagering structure for a particular gaming table. The computer interface may include a touch screen input, as described above. For example, in a Blackjack game, the dealer can input using the touch screen the minimum and maximum bet. In a poker game, the dealer can input variation of poker being played and the amount of the ante or the blinds, depending on the variation of poker being played. In one embodiment, the system enables the dealer to enter information regarding the rake percentage. Alternatively, the game parameters can be established by the casino's central computer and downloaded to the computer interface to be displayed to the dealer. Therefore, the dealer would be informed on any changes in the betting structure or house rake percentage.

In one embodiment, the gaming system includes a gaming table configured for a live poker game, where the poker game is played with a fixed limit betting structure (i.e., fixed limit poker). With this type of betting structure, a player simply chooses whether or not to bet, and the amount of the bet is fixed by the house rules. In this embodiment, the gaming system includes a computer interface with an input that enables the dealer to enter information regarding whether a player has folded, bet, or raised. Therefore, because the wagering amounts are fixed by the house rules, the dealer can quickly enter whether the player has bet or raised and the processor is able to update the size of the pot by inferring the amount of the wager from the wagering rules. In another embodiment, the computer interface includes three inputs, one for folding, betting and raising, respectively. In another embodiment, the computer interface includes an additional input that enables the dealer to correct a previous input error. In one embodiment, the gaming system further includes at least one player identification card reader. In this embodiment, the dealer is able to associate a particular player with a particular player position. Therefore, when the dealer enters wagering information, the gaming system is able to credit the player with these amounts. Accordingly, the gaming establishment is better able to identify frequent players that are deserving of special compensation rewards. This system can be employed in any of the embodiments disclosed herein.

In another embodiment, the gaming system is configurable through a central controller connected through a network, as seen in FIG. 2. In this embodiment, each gaming table includes a computer interface, as described above. The computer interface enables the gaming system to communicate with the central controller and further includes a player identification input device for player tracking. The central controller is operable to issue commands to any of the gaming system regarding required changes in wagering structure, type of game, rules for a particular game, and any changes in the rules regarding the progressive jackpot award. In response to commands from the central controller, the gaming system causes the information to be displayed to the dealer on the computer interface, enabling the dealer to implement the changes.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming system comprising:
at least one processor; and
a tracking system for a table for a card game employing at least one deck of physical playing cards, said table including a support structure, a playing surface, a plurality of player positions for a plurality of players, a dealer position and at least one wagering area,
said tracking system including at least one chip identifier configured, for each play of the card game at the table, to identify one or more chips representing an amount of each wager placed by each of the plurality of players in the at least one wagering area,
said tracking system configured, for each said play of the card game at the table, for each player, to communicate the wager amount of the wager placed by said player to the at least one processor,
said at least one processor programmed, for each player, to:
(i) for each play of the card game, update a player profile associated with said player with the identified wager amount of the wager placed by the player, and
(ii) determine a player comp rating for said player based at least in part on the total amounts wagered in the player profile associated with said player.

2. The gaming system of claim 1, wherein, for each player, the player comp rating for said player is further based on a percentage of a value of a pot for each said play of the card game at the table.

3. The gaming system of claim 1, wherein, for each player, the player comp rating for said player is further based on an amount of time said player actively plays the card game at the table.

4. The gaming system of claim 2, wherein, for each player, the player comp rating for said player is further based on an amount of time said player actively plays the card game at the table.

5. The gaming system of claim 1, wherein, for each player, the player comp rating for said player is further based on a number of plays of the card game stored in the player profile associated with said player.

6. The gaming system of claim 2, wherein, for each player, the player comp rating for said player is further based on a number of plays of the card game stored in the player profile associated with said player.

7. The gaming system of claim 2, wherein, for each player, the player comp rating for said player is based on a percentage of a house rake for each said play of the card game at the table.

8. A method of operating a gaming system, said method comprising:
(a) enabling a plurality of players to play a card game at a table, said card game employing at least one deck of physical playing cards, said table including a support structure, a playing surface, a plurality of player positions, a dealer position and at least one wagering area; and
(b) for each play of the card game at the table, for each wager placed by each of said plurality of players in the at least one wagering area:
(i) causing at least one chip identifier to identify one or more chips representing an amount of the wager placed by said player,
(ii) associating the wager with the player and communicating the identified wager amount of said wager to at least one processor, and
(iii) causing the at least one processor to update a player profile associated with said player with the identified wager amount of said wager; and
(c) for each of said plurality of players, causing the at least one processor to determine a player comp rating for said player based at least in part on the total amounts wagered in the player profile associated with said player.

9. The method of claim 8, which includes, for each of said plurality of players, causing said at least one processor to determine the player comp rating for said player based on a percentage of a value of a pot for each said play of the card game at the table.

10. The method of claim 8, which includes, for each of said plurality of players, causing said at least one processor to determine the player comp rating for said player based on an amount of time said player actively plays.

11. The method of claim 9, which includes, for each of said plurality of players, causing said at least one processor to determine the player comp rating for said player based on an amount of time said player actively plays.

12. The method of claim 8, which includes, for each of said plurality of players, causing said at least one processor to determine the player comp rating for said player based on a number of plays of the card game stored in the player profile associated with said player.

13. The method of claim 9, which includes, for each of said plurality of players, causing said at least one processor to determine the player comp rating for said player based on a number of plays of the card game stored in the player profile associated with said player.

14. The method of claim 9, which includes, for each of said plurality of players, causing said at least one processor to determine the player comp rating for said player based on a percentage of a house rake for each said play of the card game at the table.
